(19) United States
(12) Patent Application Publication
(10) Pub. No.: US 2016/0344558 A1
(43) Pub. Date: Nov. 24, 2016

(54) System and Method for Obtaining Authorization

(71) Applicants: Donald Gene Archer, Grand Prairie, TX (US); Christopher Paul Linville, Euless, TX (US); Kenneth Don West, Arlington, TX (US)

(72) Inventors: Donald Gene Archer, Grand Prairie, TX (US); Christopher Paul Linville, Euless, TX (US); Kenneth Don West, Arlington, TX (US)

(21) Appl. No.: 15/158,832

(22) Filed: May 19, 2016

Related U.S. Application Data
(60) Provisional application No. 62/164,250, filed on May 20, 2015.

(51) Int. Cl. H04L 9/32; H04W 4/00; H04W 12/06; H04L 29/08

(52) U.S. Cl. CPC H04L 9/3247; H04L 67/104; H04W 4/001; H04W 12/06

(57) ABSTRACT

A system and method for obtaining real-time authorization. The system includes a customer located on a first device. An agent is located on a second device which is remote from the first device. An authorization hub connects the first device with the second device. A customer is provided with a message requesting authorization in the form of a signature. The customer provides the signature on the first device. Along with the signature, an authenticity identifier is collected from the first device. Thereafter, the agent is notified that the signature has been received by the authorization hub. In some examples, the agent can view the customer providing the signature in real-time.

### PRIORITY

This application claims priority to provisional application No. 62/164,250 entitled “System and Method of Obtaining Authorization” filed May 20, 2015, the entirety of which is hereby incorporated by reference.

### BACKGROUND OF THE INVENTION

Technical Field

The present invention relates to a system and method for obtaining legal authorization.

Description of Related Art

Often an agent, such as an insurance agent, is tasked with obtaining or discussing information which is confidential to the client. As an example, the agent may need to access a client's medical records. Consequently, there is a need by which an agent is able to obtain legal authorization to obtain confidential client information.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic of the system in one embodiment.

FIG. 2 is a schematic illustrating the relationship between the agent, client, and the authorization hub in one embodiment;

FIG. 3 is a flow chart of customer signing the consent agreement in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

In one embodiment, an electronic process and mechanism is disclosed in which a requesting party such as an agent can obtain legal authorization to view personal details or perform some action on a customer's behalf. In one embodiment, the mechanism occurs in real-time. In one embodiment the system and method discussed herein occurs over the internet.

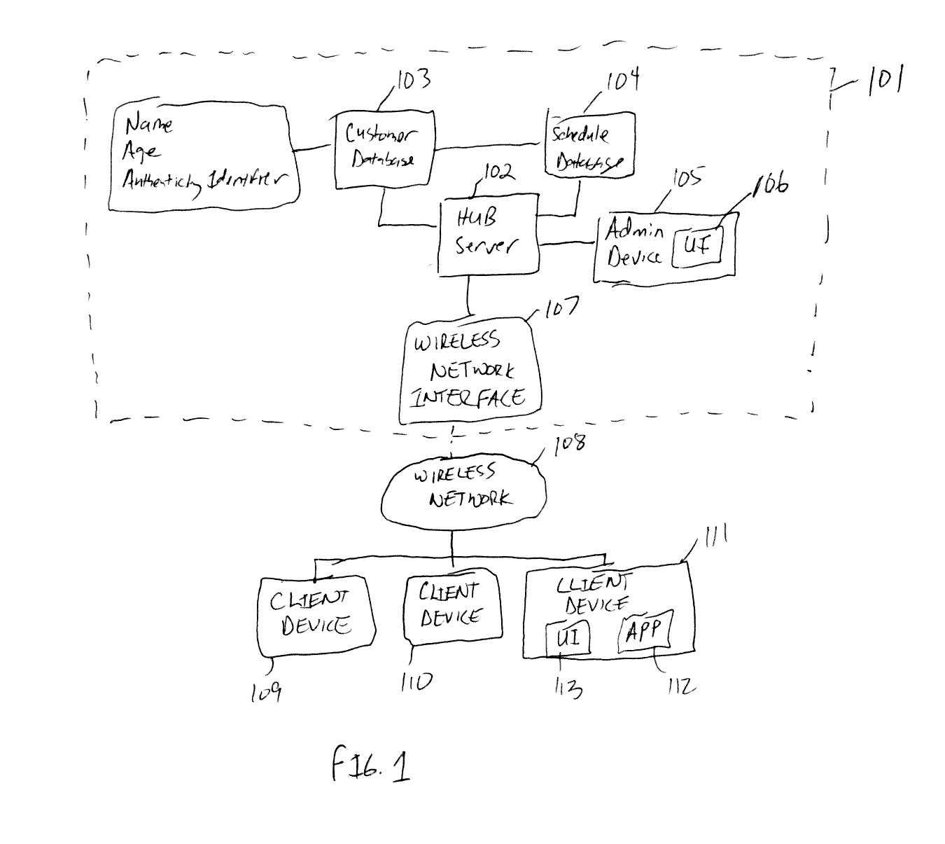

The system embodying the structure and functional elements of the presently described invention, in one embodiment, is depicted in FIG. 1. In FIG. 1, the platform 101 includes a hub server 102 including a processor and associated databases including customer database 103, which includes customer information and scheduling database 102 including scheduling data for the particular customer. Customer database 103, in one embodiment, includes data fields associated with an individual customer, as described above, including photos, signatures, voice, a digital signature discussed below, etc. In one embodiment the customer database 103 comprises authenticity identifier information and/or known signature data, discussed below herein. Scheduling database 102, in one embodiment, includes a time or date in which the agent and the customer are to meet in a real-time viewing. The platform 101 may reside remotely from client device 111 or may be a local control unit that resides locally to client device 111. A client device 111 can include a computer, laptop, portable device, smart phone, tablet, or the like. It should be understood that while a scheduling database 102 and a customer database 103 are described as separate servers this is for illustrative purposes only and should not be deemed limiting.

An administrator device 106, which may be a desktop computer, portable device, smart phone, tablet or the like, includes a user interface 105. Through this interface, an administrator or authorized personnel may set or modify parameters associated with obtaining the customers signature.

In one embodiment, hub server 102 communicates with a wireless network interface 107 to communicate over wireless network 108. Over wireless network 108, the location platform 101 may communicate with a variety of client devices 111, 110 and 109 associated with each agent and or customer. In one embodiment, and as depicted, each client device 111, 110, and 109 includes a user interface 113. In some embodiments, discussed below, the user interface 113 comprises an interface which allows the user to produce a signature either with her hand, stylus, typing, etc. In another embodiment the interface comprises the ability to capture photo, video, audio, and combinations thereof. In one embodiment, the client device is a smart phone, such as an Apple iPhone whereas in other embodiment the client device comprises a computer. As noted, in one embodiment the client device comprises a smart phone. This provides the ability to record an image, video, or audio via the phone's camera and recording equipment. In one embodiment the client comprises a fingerprint sensor such as that provided in the iPhone via its Touch ID capability. Other smartphones include a camera and fingerprint sensor capability through which transactions may be executed with the phone. Software residing in mobile devices in conjunction with voice recording capability, such as an internal microphone or an external or detachable microphone, enable recording of an individual's voice and creation of a digital representation of the voice that may be stored in the customer database 103 for later use in connection with the platform 101. In one embodiment, an application program 112 is installed, either temporarily or permanently on client device 111. An application program 112 facilitates communication with the platform 101 and an internal wireless interface of client device 111 allows communication with other systems and devices, including platform 101 according to various wireless or cellular network protocols. In one embodiment the client device 111 comprises an application program 112 which has instructions executed by the processor of device 111.

As noted, in one embodiment an agent obtains real-time authorization from a customer through an authorization hub. The requesting party, referred to herein as an agent, can be any party which is working with a customer and which is requesting personal or confidential information regarding a customer. The requesting agent can be an attorney, a realtor, a banker, a loan officer, an insurance agent, etc. which is in need of authorization from a customer or client.

In one embodiment the agent, is communicating with a customer. The communication can be over the phone, in person, chat, email, or other direct or indirect method of communication. At some point, the agent will require authorization to access the customer's records or perform some action on the customer's behalf. This can happen in several different scenarios. As one example, consider a scenario whereby the agent is an insurance agent. The agent will speak to the customer over the phone, but at some point will require a signature or authorization from the customer. Typically, the process would be halted and the customer would be sent a letter, email, etc. which the customer would then later sign. After the customer has signed, the agent, generally several days later, can pick up the application again and proceed to necessary subsequent steps. This process is slow, inefficient, and often the customer does not follow through with subsequent steps. Accordingly, in one embodiment the authorization occurs in real-time whereby the agent can witness, in real time, an authorization occur. Thereafter, the agent can continue with the process.

Continuing with the above example of an insurance agent, the agent will obtain necessary background information about the customer. At the point where the customer must sign or authorize a specific action or step, the customer is prompted to an authorization screen through an authorization hub, described herein. The customer can then sign, with the agent still on the phone, and the agent can witness, in real-time, the signature of the customer. The agent can then complete the process with the customer still on the phone. This embodiment provides a superior and more efficient system and method of obtaining authorization compared to the prior art.

As noted, in one embodiment the customer authorization is obtained and viewed in real-time. An example of one embodiment will now be described. In one embodiment the agent will use a browser or other client device 111 to launch or visit a web application containing the platform 101. The web application in communication with the platform 101 can be located on a website, or it can be located on an agent's smart phone, computer, tablet, or other such device.

In one embodiment, and as depicted, the client device 111 is in communication with the platform 101 via a wireless network 108 such as the cloud. This allows the agent's device 111 to communicate and connect with the platform 101.

Next, the agent will then obtain a customer's contact information. The contact information can comprise any contact information which allow the customer to be contacted via electronic means. Electronic means includes, but is not limited to, an email address, social medial handle or name, phone number for texting, etc.

After obtaining the customer's contact information, the agent sends a message to the customer. The message can originate directly from the agent, or the agent can provide the platform 101 with the customer's contact information, and the platform 101 contacts the customer.

In one embodiment the authorization hub will deliver a message, via the contact information previously provided, to the customer. In one embodiment, the delivery occurs immediately after the agent hits send.

The message, in one embodiment, contains a link to an authorization page on the authorization hub. The link can comprise any link, including but not limited to, a hyperlink, a web address, etc. The link can comprise security information such as a password, etc. which the customer must enter before gaining access to the authorization page. The link, in one embodiment, comprises any direction or path by which the customer can gain virtual access into a virtual authorization page. Upon receiving the message, the customer can click or otherwise follow the link and view the details of the message and/or request from the agent.

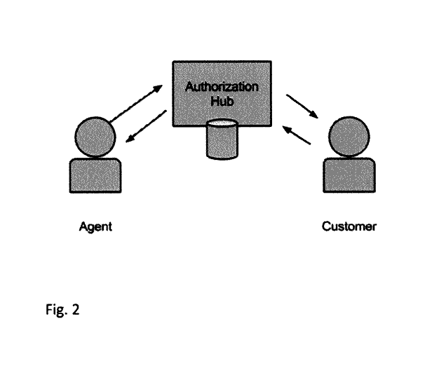

In one embodiment, once the customer accesses the authorization page, the web page will establish a real-time connection to the authorization hub between the customer and the client. FIG. 2 is a simplified schematic illustrating the relationship between the agent, customer, and the authorization hub in one embodiment. As noted, the authorization hub, the platform 101, can comprise a server or a plurality of servers which are coupled to one or a plurality of databases. The authorization hub can be located near the agent or the authorization hub can be located remotely from the agent.

The details of the message can include virtually any information and may include, but is not limited to, the agent's company name, the agent's name, a description and scope of the request, time of the request, duration of the request, a copy of the contract or agreement, etc. The message can include virtually any agreement or contract which can be signed and bound a party. The message can include a mortgage agreement, a rental agreement, an employment agreement, a business contract, an insurance agreement, etc.

The message, in one embodiment, provides the customer with an opportunity to sign and authorize the message or request. In one embodiment the message is a request to view a customer's information, including confidential information. The request can also include an authorization to perform an act or actions on behalf of the customer. The request can also include an appointment of the agent, such as appointing the agent to be a legal representative, power of attorney, etc. Thus, in one embodiment the customer is provided with an opportunity to authorize the message and or the request in the message. As used herein, authorize means to be bound or agree to the terms of the message or the request. Thus, if a message is a contract, authorize means to sign and be bound by the terms of the contract. If the message is a request, the authorization is response in the affirmative that the request is granted.

In one embodiment, the customer provides authorization by providing a digital signature package. As used herein a digital signature package comprises at least a signature. In one embodiment the digital signature package comprises at least one signature and one authenticity identifier. The signature can comprise any form, including typing the customer's name or other identifying information. In other embodiments the customer signs the digital signature with a finger, thumb, or stylus such that the signature looks like a traditional ink signature. A signature which resembles a traditional ink signature is referred to as an ink-like signature herein. An ink-like signature, as noted, can be created with a finger, thumb, stylus, mouse, pointer, etc. In one embodiment, the digital signature approves the access requested and appoints the agent as a legally authorized representative. The extent of the approval is dependent upon the language in the message.

The authenticity identifier can comprise any piece of additional data which can be used to authenticate the identity of the signor. The authenticity identifier can comprise visual, audio, or other data which can be used to authenticate identity. For example, in one embodiment the authenticity identifier comprises a photo. Either before, after, or simultaneous with providing the signature, a photograph of the signor is captured. The photograph can then be cross-checked with other photographs of the signor to verify and corroborate the identity of the signor. Likewise, the voice of the signor can be recorded and cross-checked to verify and corroborate the identity of the signor. Thus, in one embodiment the device captures photographs, video, or audio data as the authenticity identifier.

The authenticity identifier, in one embodiment, comprises security questions which can be used to verify the identity of the signor. In other embodiments the authenticity identifier comprises biometric data such as finger print scan, retinal scan, etc. Such biometric data can be used to verify and corroborate the identity of a signor. In one embodiment the biometric data is obtained at the customer's device.

In other embodiments the signature further comprises the authenticity identifier. For example, in one embodiment the time, speed, pressure, and/or movements of the signature are recorded and captured to serve as an authenticity identifier. When a person provides a signature, there are identifying characteristics, other than the look of the signature, which can be used to identify the authenticity of the signature. Put differently, while a forger may be able to recreate the look of the signature, they may not be able to recreate the fluidity of the signor, as an example. An authentic signature, while looking like the forged signature, may have been made by crossing a “T” in a name immediately whereas the forgery may cross the “T” at a later point in time. Accordingly, in one embodiment the authenticity identifier comprises data related to the time, speed, pressure, and/or movements of the signature as it is being made.

In one such embodiment, for example, the location at the point at which the signature is being made is recorded along an X-Y axis. The position of the point can be recorded over time as the signature is created to provide an XY position coordinates over time. The XY coordinates recovered by the client device can then be cross-checked with other known coordinates to verify the authenticity of the signature. Referring back to the crossing the “T” example, if the forgery crossed the “T” after the last name was formed, and the authentic signature had a “T” which was crossed sooner in time, such an indicator would suggest the signature was not authentic. Additionally, if an authentic signature typically takes the user 1.2 seconds to create, and the recorded signature required 8 seconds, this is an indication that the signature might not be authentic.

While XY coordinates and time have been described, this is for illustrative purposes only and should not be deemed limiting. Other identifying characteristics found in a signature can likewise be tracked and cross-checked. As but an additional, non-limiting example, the pressure applied when making certain letters, to begin the signature, etc. is an additional characteristic which can be recorded, tracked, and compared.

Even when a user types their signature, the timing of the signature can serve as an authenticity identifier which can be used to identify and corroborate a typed signature. Thus, in one embodiment the authenticity identifier comprises the timing of a signature being typed.

As noted, in one embodiment the authenticity identifier is collected at the customer's device. In one embodiment the authenticity identifier is then transmitted to the platform 101.

In one embodiment the authenticity identifier is collected and stored for later use. In such embodiments, the authenticity identifier will be available if a customer later challenges the authenticity of the provided signature. In other embodiments, however, the authenticity identifier is cross-checked immediately. The cross-check step can comprise any cross-check method or device known in the art. For example, in one embodiment the authenticity identifier is compared to known signature data. Known signature data is data which is known to be accurate and verified. In one embodiment, known signature data is data which previously existed. This includes previously existing biometric data, photographic data, voice recordings, signature related information. The known signature data can be a signature which was previously prepared in front of a witness and recorded. The known signature data, in one embodiment, comprises data related to the authenticity identifier. In the embodiments using XY coordinates, the XY coordinates of the collected signature is compared to the XY coordinates of a known and verified, generally pre-collected, signature. The known and verified signature data can be stored on the platform, or on other databases or servers in communication with the platform. If the collected authenticity identifier is within an acceptable tolerance of the known data, the signature package is accepted. If the collected authenticity identifier is not within an acceptable tolerance, the signature package is rejected. As noted, in one embodiment the signature is authenticated in real-time.

The ability to authenticate the signature at the time the signature is made is a tremendous benefit. First, it is an additional security step. Second, it helps prevent identity theft and other types of fraud. Third, it provides security to both parties that the signed document is valid and enforceable.

As noted, in one embodiment the agent is allowed to witness the signature in real-time. In one such embodiment the agent is provided a viewing window in which the agent can witness the signature as it is being made. This allows a seamless transition and decreases delay and wait time. As noted, rather than having to wait several hours, days, or weeks to receive the signature before proceeding to the next step, the agent can witness, in real-time the signature being made. Thereafter, in some embodiments, the authenticity of the signature is verified.

In one embodiment, once signed, the authorization hub will record the IP address, time, and name of the customer to save and store this data as part of the customer's total digital signature package. When the authorization hub receives a completed signature, it will notify the requesting agent. In one embodiment, the authorization hub notifies the requesting agent by sending a message back through the open connection. The agent can then continue by gaining access to the requested data or process.

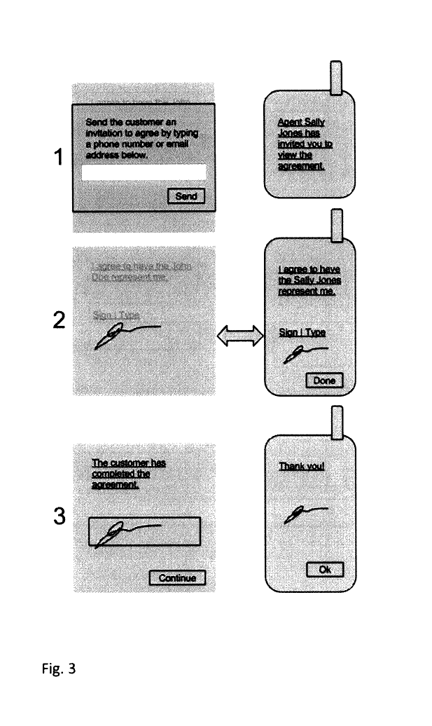

FIG. 3 is a flow chart of customer signing the consent agreement in one embodiment. In the first step depicted, the agent would send an invitation to agree via SMS or email. The customer would click a link via the SMS or email to go to the signature screen.

In the second step depicted, while the agent is waiting on a signature, the agent can watch the customer sign the agreement in real-time as discussed above.

In the third step depicted, when the customer is finished they can click “Done” and the online agent will see the results of the completed signature. After the customer has completed the signature, the process is either complete is the signature was the last stage, or subsequent steps can be completed, depending upon the transaction.

As discussed, one embodiment comprises a method for obtaining real-time authorization from a customer located on a first device viewable by an agent located on a second device, wherein the first and second devices are communicating via an authorization hub. In one embodiment the first and second devices are remote. Accordingly, the two devices are in two separate locations. In one embodiment the two devices are communicating with the authorization hub.

The method comprises first presenting a request for signature to a customer located on a first device. As noted, the first device can comprise a computer, tablet, smart phone, mobile device, etc. The request can originate from agent or the authorization hub.

Next, in one embodiment the agent is provided a window in which the agent located on the second device can view the signature created by the customer. In one embodiment the window allows the agent to view the signature creation in real-time. The window, in one embodiment, is viewable through a browser located on the agent's device.

Thereafter, the signature provided by the customer is received. The signature can be received by the authorization hub, the agent, or both. The agent is then notified that the customer has completed the signature.

As noted, in one embodiment the method comprises receiving an authenticating identifier. In one such embodiment the method comprises receiving an authenticating identifier which was collected by the user's device.

In one embodiment the method further comprises comparing the authenticating identifier with known signature data. Based upon the comparison of the known signature data, the signature is either approved or denied.

While one method has been described wherein the agent views the signature in real time, this is for illustrative purposes only. In other embodiments, for example, the customer is sent the message and the customer subsequently signs but the signature is not viewable in real time. In one embodiment the signature can take place hours or days after sending the message. Once the signature is complete, in some embodiments, the signature and the authenticating identifier are sent back to the authorization hub and or the agent.

The method and system discussed herein has several advantages. First, this overcomes many of the problems inherent in the prior art. In some instances, an agent would have to record audio of a spoken attestation of legal representation. In other instances, the authorization is sent by way of fax or other written documentation. In many situations this is insufficient because the recording then resides with the agent rather than a third party. The method and systems discussed herein, however, enables a more secure interaction because the digital signature can be stored and protected by a third-party. It also provides for much faster approval of the requested information to the agent by the customer. In some embodiments, the agent and customer can be on the phone while this process is underway. As such, the agent can serve the customer often with a single phone call and without requiring subsequent faxes, or other documentation which could slow the process. Further, many third-parties will require proof of the written documentation. This was difficult, if not impossible, to provide when the authorization was audio.

Additionally, as noted, because of the authenticity identifier, fraud and forgery can be reduced.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.
Clause 1. A system for obtaining a signature, said system comprising:
   a customer located on a first device;
   an agent located on a second device, wherein said first device and said second device are remote;
   an authorization hub;
   wherein a message is provided to said customer at said first device requesting authorization;
   wherein said customer provides a signature on said first device to said authorization hub, wherein said signature further comprises an authenticity identifier collected from said first device;
   wherein said agent is notified when said digital signature has been received by the authorization hub.
Clause 2. The system of any proceeding or preceding clause wherein said agent can view said signature as it is created in real-time.
Clause 3. The system of any proceeding or preceding clause wherein said first device and said second device communicate wirelessly with said authorization hub.
Clause 4. The system of claim 1 wherein one of said devices comprises a mobile device.
Clause 5. The system of any proceeding or preceding clause wherein said authorization hub sends said message to said customer.
Clause 6. The system of any proceeding or preceding clause wherein said authenticity identifier comprises data related to coordinates of the signature over time.
Clause 7. The system of any proceeding or preceding clause further comprising known signature data, and wherein said known signature data is compared to said authenticity identifier.
Clause 8. The system of any proceeding or preceding clause wherein said authenticity identifier comprises biometric data recovered from said first device.
Clause 9. The system of any proceeding or preceding clause wherein said digital signature is typed by said customer.
Clause 10. The system of any proceeding or preceding clause wherein said signature comprises an ink-like signature.
Clause 11. A method for obtaining real-time authorization from a customer located on a first device viewable by an agent located on a second device, wherein the first and second devices are communicating via an authorization hub, said method comprising:
   a) presenting a request for signature to a customer located on a first device;
   b) providing a window in which an agent located on a second device can view the signature created by the customer;
   c) receiving the signature provided by the customer.
Clause 12. The method of any proceeding or preceding clause further comprising step d) notifying the agent of a completed signature.
Clause 13. The method of any proceeding or preceding clause wherein said receiving of step c) further comprises receiving an authenticating identifier.
Clause 14. The method of any proceeding or preceding clause wherein said authenticating identifier was collected from said first device.
Clause 16. The method of any proceeding or preceding clause further comprising step d) comparing said authenticating identifier with a known signature data.
Clause 17. The method of any proceeding or preceding clause further comprising step e) approving said signature.
Clause 18. The method of any proceeding or preceding clause further comprising step e) denying said signature.
Clause 19. The method of any proceeding or preceding clause wherein said authorization hub presents said request.
Clause 20. The method of any proceeding or preceding clause wherein said agent presents said request.

What is claimed is:

1. A system for obtaining a signature, said system comprising:
a customer located on a first device;
an agent located on a second device, wherein said first device and said second device are remote;
an authorization hub;
wherein a message is provided to said customer at said first device requesting authorization;
wherein said customer provides a signature on said first device to said authorization hub, wherein said signature further comprises an authenticity identifier collected from said first device;
wherein said agent is notified when said digital signature has been received by the authorization hub.

2. The system of claim 1 wherein said agent can view said signature as it is created in real-time.

3. The system of claim 1 wherein said first device and said second device communicate wirelessly with said authorization hub.

4. The system of claim 1 wherein one of said devices comprises a mobile device.

5. The system of claim 1 wherein said authorization hub sends said message to said customer.

6. The system of claim 1 wherein said authenticity identifier comprises data related to coordinates of the signature over time.

7. The system of claim 1 further comprising known signature data, and wherein said known signature data is compared to said authenticity identifier.

8. The system of claim 1 wherein said authenticity identifier comprises biometric data recovered from said first device.

9. The system of claim 1 wherein said digital signature is typed by said customer.

10. The system of claim 1 wherein said signature comprises an ink-like signature.

11. A method for obtaining real-time authorization from a customer located on a first device viewable by an agent located on a second device, wherein the first and second devices are communicating via an authorization hub, said method comprising:
a) presenting a request for signature to a customer located on a first device;
b) providing a window in which an agent located on a second device can view the signature created by the customer;
c) receiving the signature provided by the customer.

12. The method of claim 11 further comprising step d) notifying the agent of a completed signature.

13. The method of claim 11 wherein said receiving of step c) further comprises receiving an authenticating identifier.

14. The method of claim 13 wherein said authenticating identifier was collected from said first device.

16. The method of claim 13 further comprising step d) comparing said authenticating identifier with a known signature data.

17. The method of claim 16 further comprising step e) approving said signature.

18. The method of claim 16 further comprising step e) denying said signature.

19. The method of claim 11 wherein said authorization hub presents said request.

20. The method of claim 11 wherein said agent presents said request.
